(19) United States
(12) Patent Application Publication
(10) Pub. No.: US 2006/0055241 A1
(43) Pub. Date: Mar. 16, 2006

(54) Brake system

(75) Inventors: Yutaka Mochizuki, Wako-shi (JP); Kei Oshida, Wako-shi (JP)

Correspondence Address: CARRIER BLACKMAN AND ASSOCIATES, 24101 NOVI ROAD, SUITE 100, NOVI, MI, 48375, US

(73) Assignee: Honda Motor Co., Ltd., Tokyo (JP)

(21) Appl. No.: 11/212,108

(22) Filed: Aug. 25, 2005

(30) Foreign Application Priority Data
Sep. 13, 2004 (JP) 2004-265724

(51) Int. Cl. B60T 8/60

(52) U.S. Cl. 303/155; 74/512

(57) ABSTRACT

A brake system for a steered vehicle includes: a brake pedal having a tread face, the brake pedal being disposed on the left side relative to the position of a steering axis for being operated by a driver's left foot; and a foot rest for supporting the driver's left foot and having a tread face, wherein a difference in level between the tread face of the brake pedal at a rest position thereof and the tread face of the foot rest is substantially zero. Thus, it is possible to reduce the changeover time required to move the left foot placed on the tread face of the foot rest to the tread face of the brake pedal, thereby improving the operability and the responsiveness. Moreover, since the left foot placed on the tread face of the foot rest can be placed on the tread face of the brake pedal simply by moving the left foot laterally, it is possible to prevent a sudden braking, which is unpleasant for a passenger, due to the brake pedal being depressed more strongly than expected at the instant of changing over.

### RELATED APPLICATION DATA

Japanese priority application No. 2004-265724, upon which the present application is based, is hereby incorporated in its entirety herein by reference.

### BACKGROUND OF THE INVENTION

1. Field of the Invention

The present invention relates to a brake system in which a brake pedal disposed on the left side relative to the position of a steering axis is operated by a. driver's left foot.

2. Description of the Related Art

Japanese Patent Application Laid-open No. 2002-308075 discloses an automatic transmission-equipped vehicle having no clutch pedal in which an accelerator pedal and a brake pedal are arranged on the right and left sides respectively of a steering wheel, and the accelerator pedal and the brake pedal are operated by a driver's right foot and left foot, respectively, so as to prevent the accelerator pedal and the brake pedal from being depressed erroneously as well as to reduce the time required to change over from depressing the accelerator pedal to depressing the brake pedal.

However, for a driver who is accustomed to operating a brake pedal with the right foot, it is not easy to smoothly operate the brake pedal with the left foot, leading to a problem that a delay is caused in depressing the brake pedal or the brake pedal is depressed too strongly to cause a sudden braking which is unpleasant for a passenger.

### SUMMARY OF THE INVENTION

The present invention has been accomplished under the above-mentioned circumstances, and it is an object thereof to enhance the operability of a brake pedal that is operated by a left foot, and enable even a driver unaccustomed thereto to carry out an appropriate braking operation.

In order to achieve the above-mentioned object, according to a first feature of the invention, there is provided a brake system for a steered vehicle comprising: a brake pedal having a tread face, the brake pedal being disposed on the left side relative to the position of a steering axis for being operated by a driver's left foot; and a foot rest for supporting the driver's left foot and having a tread face, wherein a difference in level between the tread face of the brake pedal at a rest position thereof and the tread face of the foot rest is substantially zero.

With the arrangement of the first feature, since the difference in level between the tread face of the brake pedal which is disposed on the left side relative to the position of the steering axis and is operated by the driver's left foot, and the tread face of the foot rest which supports the driver's left foot, is made substantially zero, it is possible to reduce the changeover time required to move the left foot placed on the tread face of the foot rest to the tread face of the brake pedal, thereby improving the operability and the responsiveness. Moreover, since the left foot placed on the tread face of the foot rest can be placed on the tread face of the brake pedal simply by moving the left foot laterally, it is possible to prevent a sudden braking, which is unpleasant for a passenger, due to the brake pedal being depressed more strongly than expected at the instant of changing over.

According to a second feature of the present invention, in addition to the first feature, an angle, relative to a vertical plane, of the tread face of the brake pedal at its rest position is equal to or less than an angle, relative to a vertical plane, of the tread face of the foot rest.

With the arrangement of the second feature, since the angle, relative to the vertical plane, of the tread face of the brake pedal at its initial position is equal to or less than the angle, relative to the vertical plane, of the tread face of the foot rest it is possible, even for a driver who is not accustomed to braking with the left foot, to maintain an angle of the ankle that easily allows power to be applied, for thereby applying a sufficient depressing force to the brake pedal.

The above-mentioned object, other objects, characteristics, and advantages of the present invention will become apparent from an illustrative, non-limiting present embodiment thereof that will be described in detail below with reference to the attached drawings.

### BRIEF DESCRIPTION OF THE DRAWINGS

FIG. 1 to FIG. 5 show one embodiment of the present invention;

FIG. 1 is an overall schematic diagram of a brake-by-wire type brake system;

FIG. 2 is a side view of a brake pedal and an accelerator pedal;

FIG. 3 is a view from the direction of arrow 3 in FIG. 2;

FIG. 4 is an enlarged view of an essential part of FIG. 2;

FIG. 5 is a graph showing the relationship between the difference in pedal level and the depression changeover time.

### DESCRIPTION OF THE PRESENT EMBODIMENT

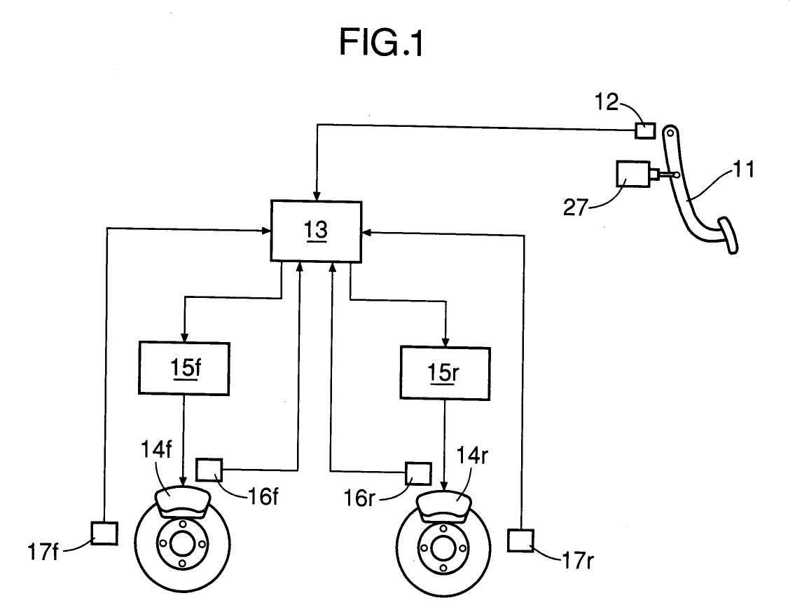

As shown in FIG. 1, a brake-by-wire type brake system includes a brake pedal 11 which will be operated by a driver's right foot. The stroke of the brake pedal 11 detected by a potentiometer 12 is inputted into a brake ECU 13. In order to make brake calipers 14f and 14r of a front wheel and a rear wheel generate a target braking force that is determined according to the stroke of the brake pedal 11, the brake ECU 13 controls the operation of brake actuators 15f and 15r connected to the brake calipers 14f and 14r. The brake actuators 15f and 15r are either of a hydraulic type in which the brake calipers 14f and 14r are operated by fluid pressure generated by an electric hydraulic pump or an electric hydraulic cylinder, or of a mechanical type in which the brake calipers 14f and 14r are directly operated by the driving force of an electric motor.

Inputted into the brake ECU13 are thrusts of pistons of the brake calipers 14f and 14r of the front wheel and the rear wheel detected by piston thrust sensors 16f and 16r, that is, actual braking forces generated by the brake calipers 14f and 14r. The brake ECU13 carries out feedback control of the operation of the brake actuators 15f and 15r so that the actual braking force coincides with the target braking force. Also inputted into the brake ECU13 are wheel speeds of the front wheel and the rear wheel detected by wheel speed sensors 17f and 17r. When the brake ECU13 detects that a given wheel has a tendency to lock, it carries out anti-lock brake control to reduce the braking force for the wheel, thus suppressing the locking.

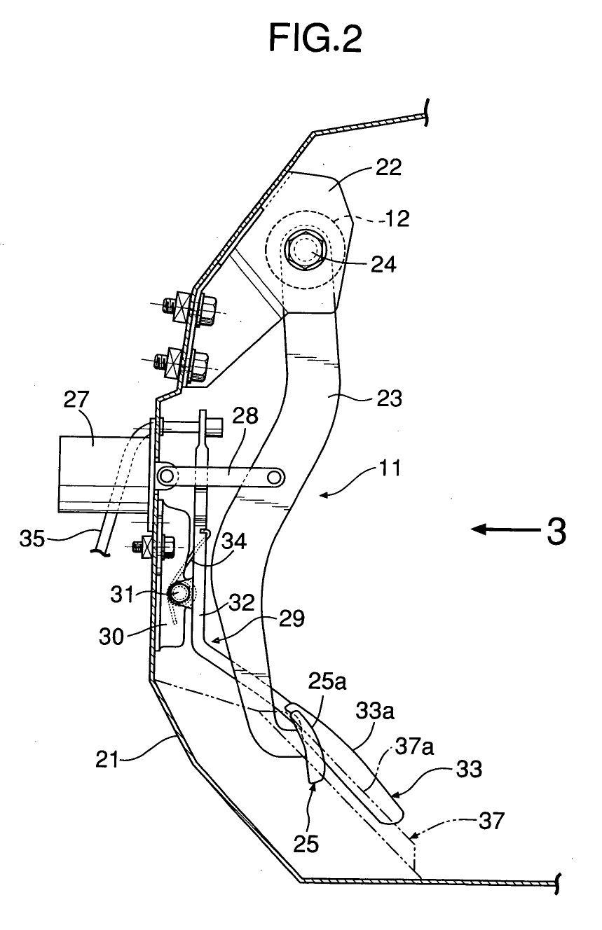

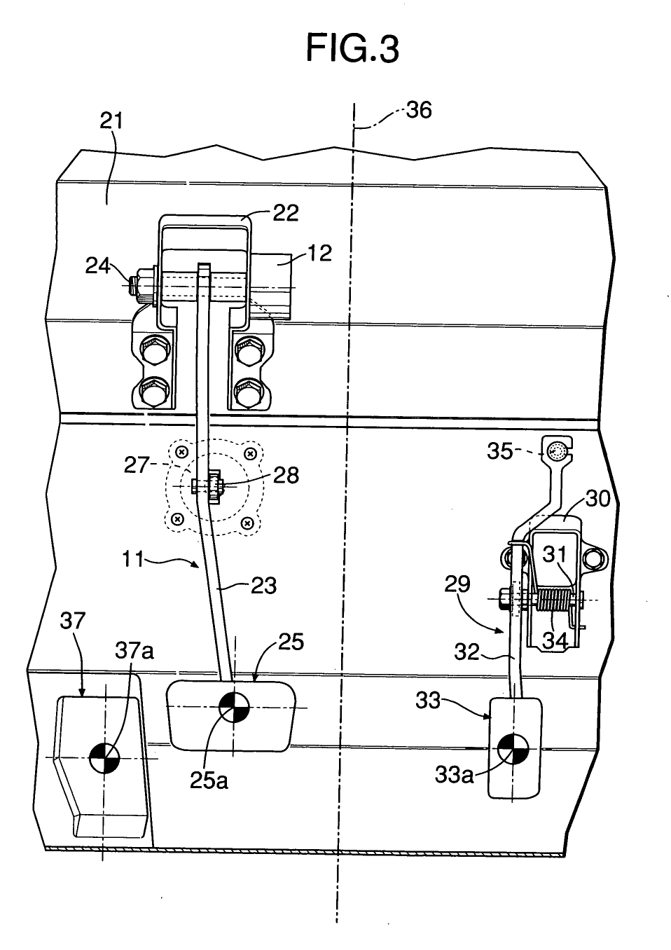

As shown in FIG. 2 and FIG. 3, the upper end of an arm portion 23 of the brake pedal 11 is pivotably supported via a support shaft 24 on a bracket 22 fixed to a dash panel 21 in front of and lower than a driver's seat; and a pedal main body portion 25 that is depressed by the sole of a driver's left foot is provided at the lower end of the arm portion 23. The potentiometer 12, which is connected to one end of the support shaft 24, detects the stroke of a tread face 25a of the pedal main body portion 25 based on the angle through which the brake pedal 11 swings. In order to give a simulated stroke and a simulated reaction force to the brake pedal 11, a stroke simulator 27 provided on the dash panel 21 and the arm portion 23 of the brake pedal 11 are connected via a rod 28. The stroke simulator 27 includes a first spring having a low spring constant and a second spring having a high spring constant, the first spring and the second spring being arranged in series. In an initial stage of the brake pedal 11 being depressed, the low spring constant first spring is compressed so as to generate an ineffective stroke that has a low reaction force and causes hardly any deceleration, and the high spring constant second spring is subsequently compressed so as to generate a reaction force corresponding to the stroke.

An accelerator pedal 29, which is operated by a driver's right foot, is formed from an arm portion 32 having a middle portion thereof pivotably supported via a support shaft 31 on a bracket 30 fixed to the dash panel 21, a pedal main body portion 33 that is provided at the lower end of the arm portion 32 and is depressed by a driver's sole, and a spring 34 that is wound around the support shaft 31 and has opposite ends secured to the bracket 30 and the arm portion 32. The upper end of the arm portion 32 is connected to a throttle valve of an engine via a Bowden cable 35.

With respect to a steering axis 36 of a steering wheel positioned in front of the driver, the accelerator pedal 29, which is operated by the right foot, is disposed on the right side, and the brake pedal 11, which is operated by the left foot, is disposed on the left side. A foot rest 37 that supports the driver's left foot is disposed on the dash panel 21 so as to be adjacent to the left side of the brake pedal 11.

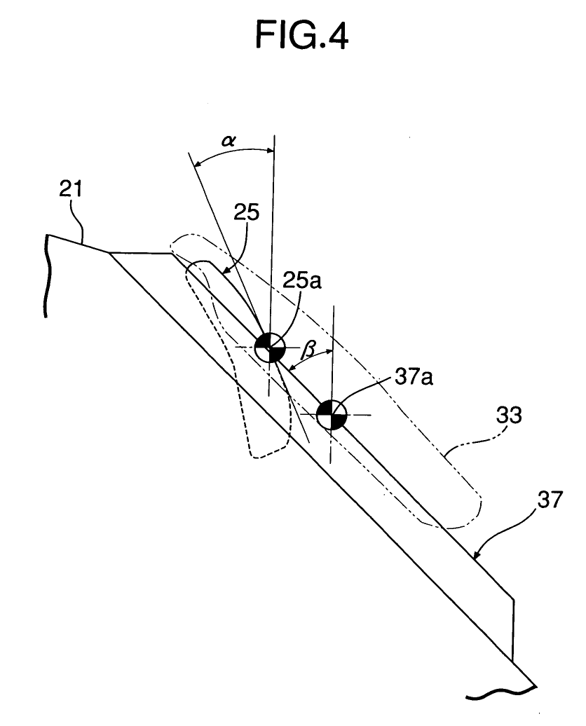

As is clear from FIG. 4, when viewed from the side with respect to a vehicle body, the position of the tread face 25a of the brake pedal 11 at its initial or rest position substantially coincides with the position of the tread face 37a of the foot rest 37, and the difference in level (difference in pedal level) between the two tread faces 25a and 37a is substantially zero. More specifically, an angle α, relative to a vertical plane, of the tread face 25a of the brake pedal 11 at its initial position is set so as to be equal or less than an angle β, relative to a vertical plane, of the tread face 37a of the foot rest 37; and the tread face 25a of the brake pedal 11 intersects the tread face 37a of the foot rest 37 in side view.

As described above, since the difference in pedal level between the tread face 37a of the foot rest 37 supporting the driver's left foot and the tread face 25a of the brake pedal 11 at its initial position is made substantially zero, it is possible to reduce the changeover time required to move the left foot placed on the tread face 37a of the foot rest 37 to the tread face 25a of the brake pedal 11, thereby improving the operability and the responsiveness.

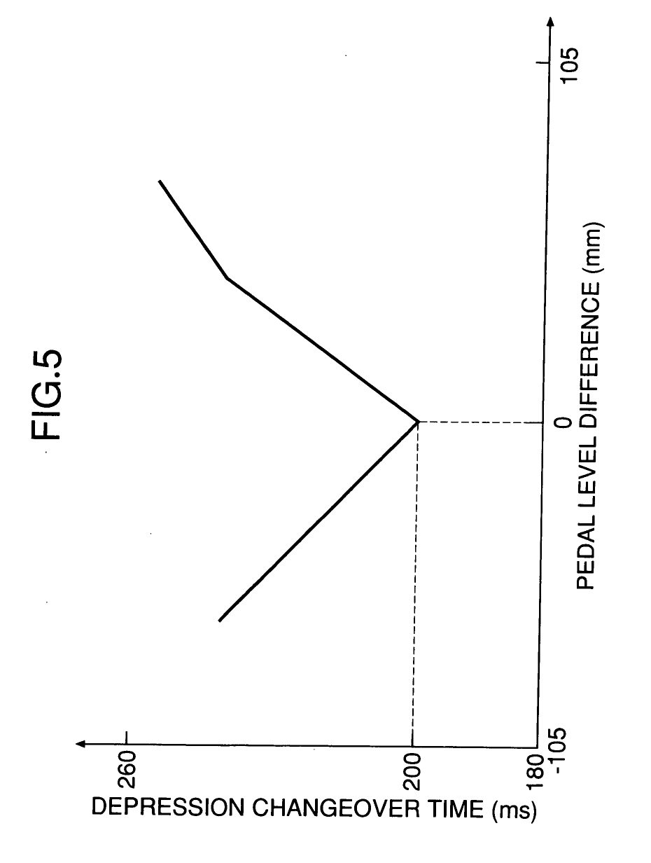

The graph of FIG. 5 shows the relationship between the difference in pedal level (abscissa) and the depression changeover time (ordinate) of the brake pedal 11. The depression changeover time of the brake pedal 11 is the time required to move the driver's foot placed on the tread face 37a of the foot rest 37 to the tread face 25a of the brake pedal 11. Since the depression changeover time becomes small when the absolute value of the difference in pedal level is small, a braking force can be generated quickly in an emergency.

Moreover, since the left foot placed on the tread face 37a of the foot rest 37 can be placed on the tread face 25a of the brake pedal 11 by simply moving the left foot laterally, it is possible to prevent a sudden braking, which is unpleasant for a passenger, due to the brake pedal 11 being depressed more strongly than expected at the instant of changing over. Furthermore, since the angle α, relative to a vertical plane, of the tread face 25a of the brake pedal 11 at its initial position is equal to or less than the angle β, relative to a vertical plane, of the tread face 37a of the foot rest 37, it is possible, even for a driver who is not accustomed to braking with the left foot, to maintain an angle of the ankle that easily allows power to be applied, thereby applying a sufficient depressing force to the brake pedal 11.

Although an embodiment of the present invention has been described above, the present invention is not limited to the embodiment, and can be modified in a variety of ways without departing from the subject matter of the present invention.

For example, a brake-by-wire type brake system is illustrated in the embodiment, but the present invention is applicable to a normal brake system. However, when the brake-by-wire type brake system is employed, since the stroke of the brake pedal 11 can be greatly shortened compared with that of a normal brake system, it is desirable for a case in which the brake pedal 11 is operated by the left foot, which is often not the dominant one.

Furthermore, the foot rest 37 is not limited to one formed from a member separate from the dash panel 21, and it may be one formed by making part of the dash panel 21 project into a vehicle compartment.

What is claimed is:

1. A brake system for a steered vehicle, comprising:
a brake pedal having a tread face, the brake pedal being disposed on a left side relative to the position of a steering axis for being operated by a driver's left foot; and
a foot rest for supporting the driver's left foot and having a tread face,
wherein a difference in level between the tread face of the brake pedal at a rest position thereof and the tread face of the foot rest is substantially zero.

2. The brake system according to claim 1 wherein an angle, relative to a vertical plane, of the tread face of the brake pedal at its rest position is equal to or less than an angle, relative to a vertical plane, of the tread face of the foot rest.

3. The brake system according to claim 1 wherein an angle, relative to a vertical plane, of the tread face of the brake pedal at its rest position is less than an angle, relative to a vertical plane, of the tread face of the foot rest.

4. The brake system according to claim 1 wherein the brake system is a brake-by-wire system and further comprises a stroke simulator connected to said brake pedal.

5. The brake system according to claim 1 wherein the foot rest is disposed adjacent to a side of said brake pedal opposite to said steering axis.
